(19) United States
(12) Patent Application Publication
(10) Pub. No.: US 2019/0271851 A1
(43) Pub. Date: Sep. 5, 2019

(54) PANEL DEVICE FOR DISPLAYING THREE-DIMENSIONAL IMAGE AND DISPLAY DEVICE COMPRISING SAME

(71) Applicant: SAMSUNG ELECTRONICS CO., LTD., Suwon-si, Gyeonggi-do (KR)

(72) Inventors: Farid MUKHTAROV, Suwon-si, Gyeonggi-do (KR); Kyung Hoon CHA, Seoul (KR)

(73) Assignee: SAMSUNG ELECTRONICS CO., LTD., Suwon-si, Gyeonggi-do (KR)

(21) Appl. No.: 16/344,466

(22) PCT Filed: Oct. 18, 2017
(86) PCT No.: PCT/KR2017/011549

§ 371 Date: Apr. 24, 2019

(30) Foreign Application Priority Data
Oct. 31, 2016 (KR) 10-2016-0143151

(51) Int. Cl. G02B 27/22

(52) U.S. Cl. CPC G02B 27/2214; H04N 13/305

(57) ABSTRACT

A panel apparatus according to an embodiment of the disclosure includes a display panel including a cluster in which a plurality of pixels are arranged in a first vertical line and a second vertical line adjacent to the first vertical line in a zigzag pattern, and an optical device disposed on a front surface of the display panel to cover an entire portion of the cluster. The pixels arranged in the first vertical line display an image taken at a first point of view and the pixels arranged in the second vertical line display an image taken at a second point of view. In addition, various embodiments understood through the specification are possible.

### TECHNICAL FIELD

The disclosure relates to a panel apparatus for displaying a three dimensional (3D) image and a display apparatus including the same.

### BACKGROUND ART

A display apparatus is an apparatus to display an image on a display, and may display not only a two dimensional (2D) image but also a 3D image. The 3D image may be implemented by simultaneously displaying images at various points of view on the display. A user may feel the stereoscopic effect through the 3D image displayed on the display.

Systems for display the 3D image on the display may be classified into a glass-free system allowing a user to view the 3D image without glasses and a glass-type system allowing the user to view the 3D image with glasses.

The glass-type system may stably provide the 3D image to the user, but there is inconvenience that the user has to wear glasses. Accordingly, recently, development has been continuously carried out regarding the glass-free system.

### DISCLOSURE

### Technical Problem

To display the 3D image, images taken at multiple points of view have to be alternately displayed on a plurality of pixels of a display panel. The lights emitted from the plurality of pixels may form a plurality of viewing zones at specified areas by passing through optical devices disposed on the front surface of the display panel. When the lights emitted from the plurality of pixels interfere with each other, the plurality of viewing zones formed at specified positions may overlap with each other to generate crosstalk.

In addition, when a plurality of pixels are disposed at a portion of the display panel to prevent the crosstalk, a zone, in which an image is not formed, may be formed between the plurality of viewing zones formed at the specified positions, which is a Moire pattern.

Various embodiment of the disclosure provide a panel apparatus for displaying a three dimensional (3D) image and a display apparatus including the same, capable of reducing the crosstalk and Moire by using a cluster, in which a plurality of pixels are arranged, and an optical device to cover the cluster.

### Technical Solution

According to the disclosure, a panel apparatus may include a display panel including a cluster in which a plurality of pixels are arranged in a first vertical line and a second vertical line adjacent to the first vertical line in a zigzag pattern, and an optical device disposed on a front surface of the display panel to cover an entire portion of the cluster. The pixels arranged in the first vertical line may display an image taken at a first point of view and the pixels arranged in the second vertical line may display an image taken at a second point of view.

According to the disclosure, a display apparatus may include a display, and a processor to display an image on the display. The display may include a display panel including a cluster in which a plurality of pixels are arranged in a first vertical line and a second vertical line adjacent to the first vertical line in a zigzag pattern, and an optical device disposed on a front surface of the display panel to cover an entire portion of the cluster. The pixels arranged in the first vertical line may display an image taken at a first point of view and the pixels arranged in the second vertical line may display an image taken at a second point of view.

### Advantageous Effects

As described above, according to the disclosure, in the panel apparatus and the display apparatus including the same, the plurality of clusters having the plurality of pixels arranged in a zigzag pattern are spaced apart from each other by specified distances, and the optical devices are disposed with respect to the plurality of clusters, respectively to cover the entire portions of the clusters, thereby reducing the crosstalk in which the plurality of viewing zones formed at specified positions overlap with each other and Moire caused as the zone, in which the image is not formed, is formed between the plurality of viewing zones.

Besides, a variety of effects directly or indirectly understood through the disclosure may be provided.

### DESCRIPTION OF DRAWINGS

FIG. 1 is a view illustrating a panel apparatus, according to various embodiments of the disclosure;

FIGS. 2A and 2B are views illustrating a display panel having the lenticular lens disposed therein, according to an embodiment of the disclosure;

FIG. 3 is a view illustrating a plurality of pixels arranged in one of a plurality of clusters, according to an embodiment of the disclosure;

FIG. 4 is a view illustrating that a plurality of viewing zones are formed from one cluster, according to an embodiment of the disclosure;

FIG. 5 is a view illustrating the panel apparatus including a plurality of display panels, according to an embodiment of the disclosure;

FIGS. 6A and 6B are views illustrating a display panel having a curved lenticular lens disposed therein, according to an embodiment of the disclosure; and

FIG. 7 is a block diagram illustrating components of a display apparatus, according to an embodiment of the disclosure.

### MODE FOR INVENTION

Hereinafter, various embodiments of the disclosure may be described with reference to accompanying drawings. Accordingly, those of ordinary skill in the art will recognize that the disclosure is not limited to a specific embodiment, modifications, equivalents, and/or alternatives on an embodiment in the disclosure can be variously made without departing from the scope and spirit of the disclosure. In the following description made with respect to the accompanying drawings, similar components will be assigned with similar reference numerals.

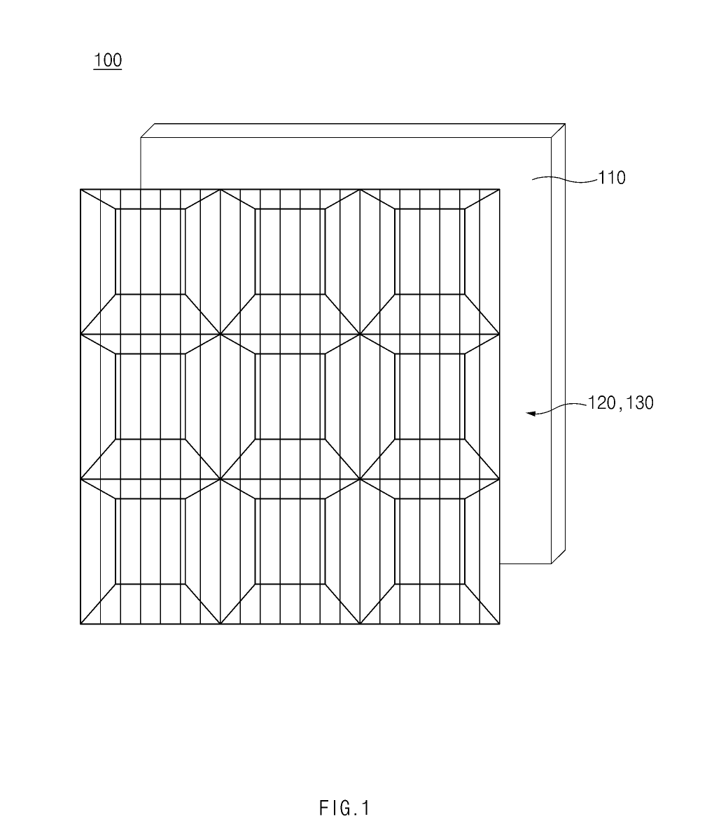

FIG. 1 is a view illustrating a panel apparatus, according to various embodiments of the disclosure.

Referring to FIG. 1, a panel apparatus 100 may display a 3D image on a display. The panel apparatus 100 may include a display panel 110 and a lenticular lens 120 to display the 3D image. The 3D image (e.g., a 3D video image) may be an image allowing a user to feel a stereoscopic effect.

According to an embodiment, the panel apparatus 100 may display images, which are taken at multiple points of view, on the display panel 110 to display the 3D image. For example, the images taken at the multiple points of view may be alternately displayed on specified pixels of the display panel 110. The images alternately displayed may be, for example, a left-eye image and a right-eye image.

According to an embodiment, lights corresponding to the images taken at the multiple points of view, which are displayed on the display panel 110, may pass through the lenticular lens 120 to form a plurality of viewing zones. For example, adjacent viewing zones of the plurality of viewing zones may be a left-eye viewing zone and a right-eye viewing zone. According to another embodiment, lights corresponding to the left-eye image and the right-eye image displayed on the display panel 110 may be selectively transmitted by a parallax barrier to form a plurality of viewing zones. Accordingly, a user of the panel apparatus 100 may feel the stereoscopic effect of the image displayed on the display panel 110 through optical devices (e.g., the lenticular lens 120 and the parallax barrier).

When the panel apparatus 100 alternately displays the images taken at the multiple points of view on specified pixels of the display panel 110, lights, which are emitted from the specified pixels, may interfere with each other due to the structure and the arrangement of the optical device. Accordingly, the plurality of viewing zones formed at the specified positions may overlap with each other, which is called crosstalk. In addition, when a plurality of pixels are arranged at some areas of the display panel 110, a zone, in which an image is not displayed, may be formed between the plurality of viewing zone, which is called a Moire pattern. According to the disclosure, the panel apparatus 100 may reduce the crosstalk and the Moire by using a cluster, in which the plurality of pixels are arranged, and an optical device to cover the cluster.

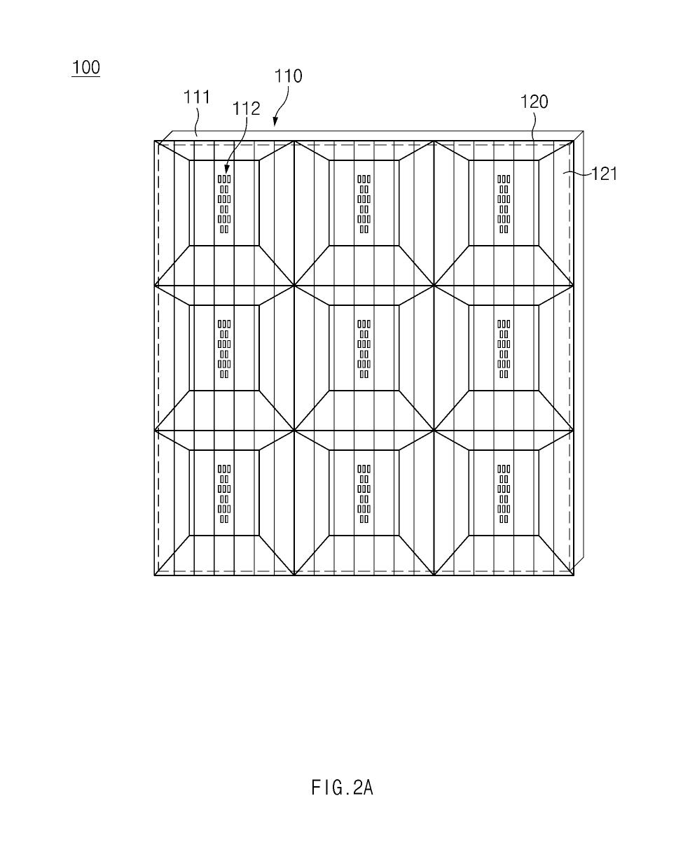

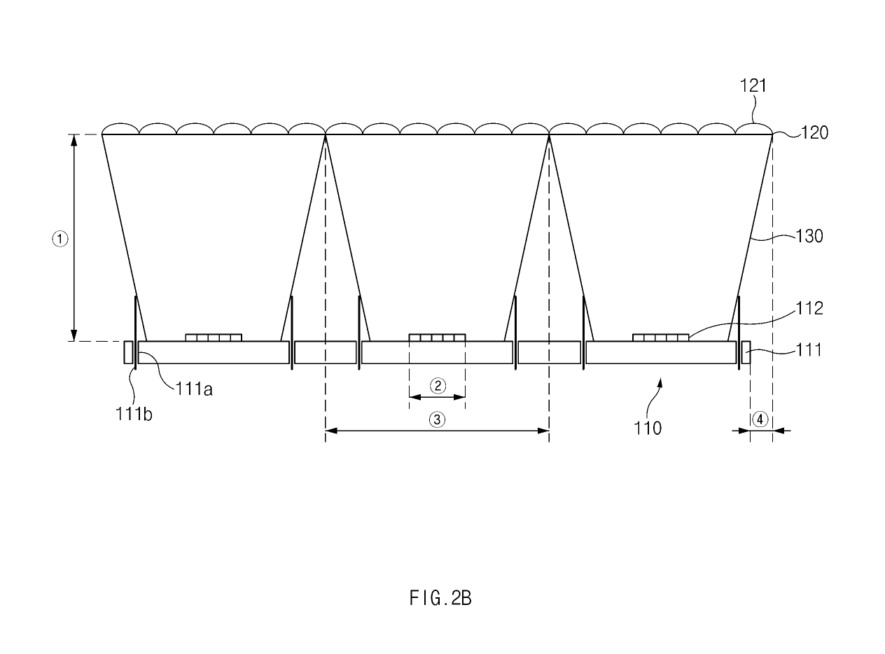

FIGS. 2A and 2B are views illustrating the display panel having the lenticular lens disposed therein, according to an embodiment of the disclosure.

Referring to FIGS. 2A and 2B, the panel apparatus 100 may include the display panel 110, the lenticular lens 120, and a spacer 130.

The display panel 110 may include a printed circuit board 111 and a cluster 112. For example, the display panel 110 may be an organic light emitting diode (OLED) panel.

A plurality of clusters 112 may be disposed on the PCB 111. For example, the plurality of clusters 112 may be arranged to be spaced apart from each other by a specified distance.

According to an embodiment, the lenticular lens 120 and the spacer 130 interposed between the display panel 110 and the lenticular lens 120 may be disposed on the PCB 111. The lenticular lens 120 and the spacer 130 may be disposed on each of the plurality of clusters 112. For example, the PCB 111 may include a plurality of through holes 111a and a plurality of fixing members 111b. The through holes 111a may be formed around the spacer 130. The fixing member 111b is coupled to a lower end of the spacer 130 through the through hole 111a to fix the spacer 130 to the PCB 111.

The cluster 112 may include a plurality of pixels. For example, the cluster 112 may include the specified number of pixels depending on images taken at multiple points of view. The plurality of pixels may be, for example, arranged in the form of a matrix, and the images taken at the multiple points of view may be alternately displayed on pixels arranged in a plurality of vertical lines or pixels arranged in a plurality of horizontal lines.

According to an embodiment, the plurality of pixels of the cluster 112 may include a light emitting device (LED). The LED may occupy a partial area (e.g., a smaller area) of the PCB 111 when the LED is disposed on the PCB 111 because the LED has a small size. The plurality of pixels including the LED may be included in the cluster 112 to be arranged in the form of a matrix.

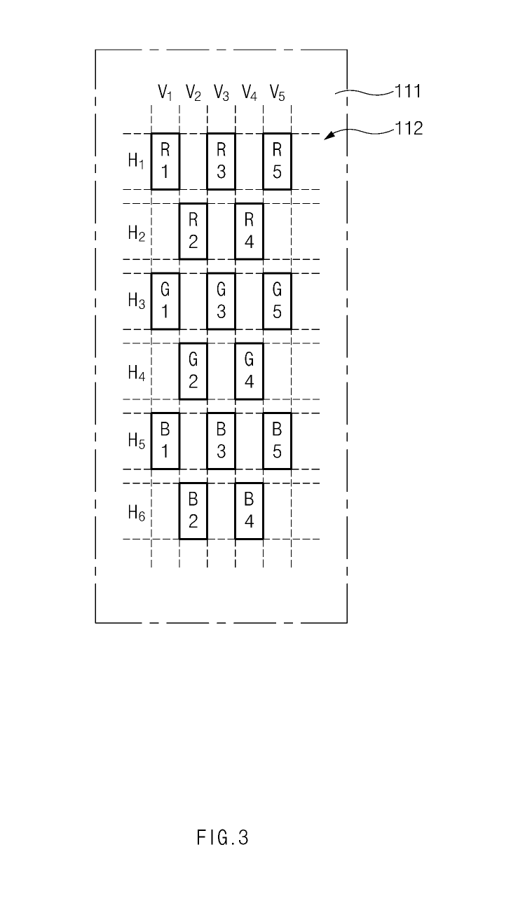

FIG. 3 is a view illustrating a plurality of pixels arranged in one of a plurality of clusters, according to an embodiment of the disclosure.

Referring to FIG. 3, a plurality of pixels in the cluster 112 may be arranged in a plurality of vertical lines V₁ to V₅ and a plurality of horizontal lines H₁ to H₅. According to an embodiment, pixels arranged in the plurality of vertical lines V₁ to V₅ may display each of images taken at the multiple points of view. For example, pixels arranged in a first vertical line V₁ to a fifth vertical line V₅ may display each of images taken at a first point of view to a fifth point of view. Accordingly, the panel apparatus 100 may display the images taken at the multiple points of view (e.g., five points of view) on the display.

According to an embodiment, the plurality of pixels in the cluster 112 may be arranged in the plurality of vertical lines V₁ to V₅ and the plurality of horizontal lines H₁ to H₅ while forming a zigzag pattern. For example, a plurality of pixels arranged in two adjacent vertical lines (e.g., the first vertical line V₁ and the second vertical line V₂) may be arranged in a zigzag pattern.

According to an embodiment, the plurality of vertical lines V₁ to V₅ may be arranged without overlapping with each other. Accordingly, lights emitted from a plurality of pixels arranged in the plurality of vertical lines V₁ to V₅ do not interfere with each other, so a plurality of viewing zones formed at specified positions may not overlap with each other. According to an embodiment, the plurality of vertical lines V₁ to V₅ may be arranged without spacing. Accordingly, a black zone (e.g., a zone in which an image is not displayed) may not be formed between the plurality of viewing zones formed at specified positions.

According to an embodiment, the plurality of horizontal lines H₁ to H₅ may be arranged without overlapping with each other. For example, the plurality of vertical lines H₁ to H₅ may be arranged without overlapping with each other for the space for mounting a plurality of pixels arranged in the plurality of vertical lines H₁ to H₅ on the PCB 111.

According to an embodiment, the plurality of pixels in the cluster 112 may include a plurality of R pixels R₁ to R₅, G pixels G₁ to G₅, and B pixels B₁ to B₅. The plurality of R pixels R₁ to R₅, G pixels G₁ to G₅, and B pixels B₁ to B₅ may constitute respective unit pixels to display images. The plurality of R pixels R₁ to R₅, G pixels G₁ to G₅, and B pixels B₁ to B₅ may be arranged in the plurality of vertical lines V₁ to V₅ to display images taken at multiple points of view. The first R pixel R₁, the first G pixel G₁, and the first B pixel B₁ may be, for example, arranged in the first vertical line V₁ to display the image taken at the first point of view. The second R pixel R₂, the second G pixel G₂, and the second B pixel B₂ may be, for example, arranged in the second vertical line V₂ to display the image taken at the second point of view.

Accordingly, the panel apparatus 100 may prevent the images taken at multiple points of view, which are displayed on the cluster 121, from overlapping with each other and being viewed by the user.

According to another embodiment, the display panel 110 may include a liquid crystal display (LCD) panel and a plasma display panel (PDP). For example, when the display panel 110 is an LCD panel, the display panel 110 may include liquid crystal and a back light unit (BLU) and a plurality of pixels may include the liquid crystal and the BLU. As another example, when the display panel 110 is the PDP panel, the plurality of pixels may include phosphor materials.

The lenticular lens 120 in the FIGS. 2A and 2B is disposed on the front surface of the display panel 110 to cover the entire portion of the cluster 112. According to an embodiment, the lenticular lens 120 may be disposed to be spaced apart forward from the display panel 110 by a specified distance \textcircled{1}. The lenticular lens 120 may cover an area \textcircled{3} wider than the cluster 112 (e.g., an area, in which the cluster 112 is provided, in the display panel 110). For example, the distance \textcircled{1} between the lenticular lens 120 and the display panel 110 and the area \textcircled{3} to cover the display panel 110 may be varied depending on the arrangement of the plurality of pixels and the plurality of viewing zones.

According to an embodiment, a plurality of lenticular lenses 120 may cover a plurality of clusters 112 disposed on the display panel 110, respectively. For example, the lenticular lens 120 to cover a cluster 112 disposed at the outermost portion of the display panel 110 may cover an external area \textcircled{4}of the display panel 110. Accordingly, the plurality of lenticular lenses 120 may cover the entire portion of the display panel 110.

According to an embodiment, the lenticular lens 120 may include a plurality of lenslets 121. For example, the plurality of lenslets 121 may be disposed on a plane parallel to the display panel 110. The plurality of lenslets 121 may be parallel to the vertical lines of the plurality of pixels arranged in the display panel 110. Accordingly, the lights emitted from pixels arranged in the plurality of vertical lines V₁ to V₅ may form a plurality of viewing zones at specified positions through the lenticular lens 120.

According to another embodiment, the parallax barrier may be disposed on the front surface of the display panel 110 instead of the lenticular lens 120. The parallax barrier may include a plurality of slits such that a light transmission area and a light blocking area are formed and may selectively transmit lights corresponding to images taken at multiple points of view. For example, the parallax barrier may be parallel to the display panel 110. The plurality of slits may be parallel to the vertical lines for the plurality of pixels arranged in the display panel 110. Accordingly, lights emitted from the pixels arranged in the plurality of vertical lines V₁ to V₅ may form a plurality of viewing zones at specified positions through the parallel barrier.

The spacer 130 in FIGS. 2A and 2B is interposed between the display panel 110 and the lenticular lens 120 to maintain the specified distance between the display panel 110 and the lenticular lens 120. For example, the spacer 130 may be fixed to the display panel 110 through the through hole 111a in the PCB 111 and the fixing member 111b.

According to an embodiment, the spacer 130 may be formed around the cluster 112, and may be formed to be inclined outward of the cluster 112. For example, the lenticular lens 120 may cover an area wider than the cluster 112, so the spacer 130 may be formed to be inclined outward of the cluster 112.

According to an embodiment, the surface of the spacer 130 may be formed of a material to absorb a light. For example, the spacer 130 may include a material to absorb a light. As another example, the material to absorb the light may be coated on the surface of the spacer 130 or a sheet to absorb the light may be attached to the surface of the spacer 130. When the surface of the spacer 130 includes a material to absorb the light, the light emitted from the cluster 112 having the spacer 130 may not pass through the lenticular lens 120 to cover another cluster 112 via the spacer 130. Accordingly, the plurality of viewing zones formed at specified positions may not overlap with each other.

According to an embodiment, a plurality of spacers 130 may be interposed between a plurality of clusters 112, which are disposed on the display panel 110, and a plurality of lenticular lenses 120.

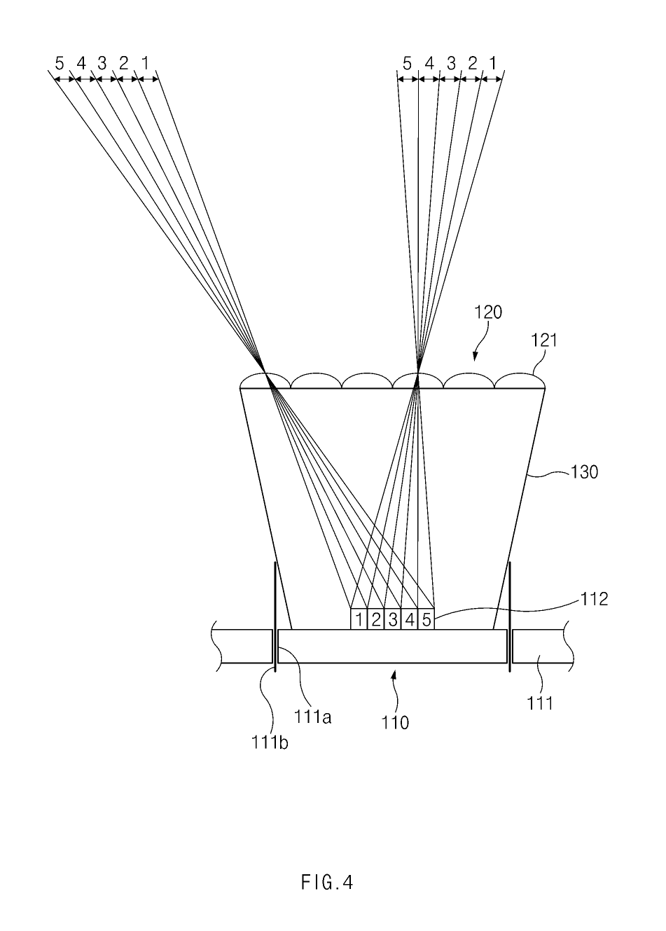

FIG. 4 is a view illustrating that a plurality of viewing zones are formed from one cluster, according to an embodiment of the disclosure.

According to an embodiment, a plurality of pixels arranged in a plurality of vertical lines V₁ to V₅ of the cluster 112 may display images 1 to 5 taken at multiple points of view, and lights emitted from the plurality of pixels may form a plurality of viewing zones 1′ to 5′ at specified positions through a lenslets of the lenticular lens 120. For example, lights emitted from a plurality of pixels, on which the image 1 taken a first point of view is displayed, arranged in the first vertical line V₁ may form a first viewing zone 1′ through the lenslet 121. As another example, lights emitted from a plurality of pixels, on which the image 2 taken a second point of view is displayed, arranged in the second vertical line V2 may form a second viewing zone 2′ through the lenslet 121. Two adjacent viewing zones of the plurality of viewing zones 1′ to 5′ may be, for example, a left-eye viewing zone and a right-eye viewing zone.

According to an embodiment, the lights emitted from the plurality of pixels may repeatedly form the plurality of viewing zones 1′ to 5′ at specified positions through the plurality of lenslets 121 of the lenticular lens 120. For example, two adjacent viewing zones of the plurality of viewing zones 1′ to 5′ which are repeatedly formed may be, for example, a left-eye viewing zone and a right-eye viewing zone.

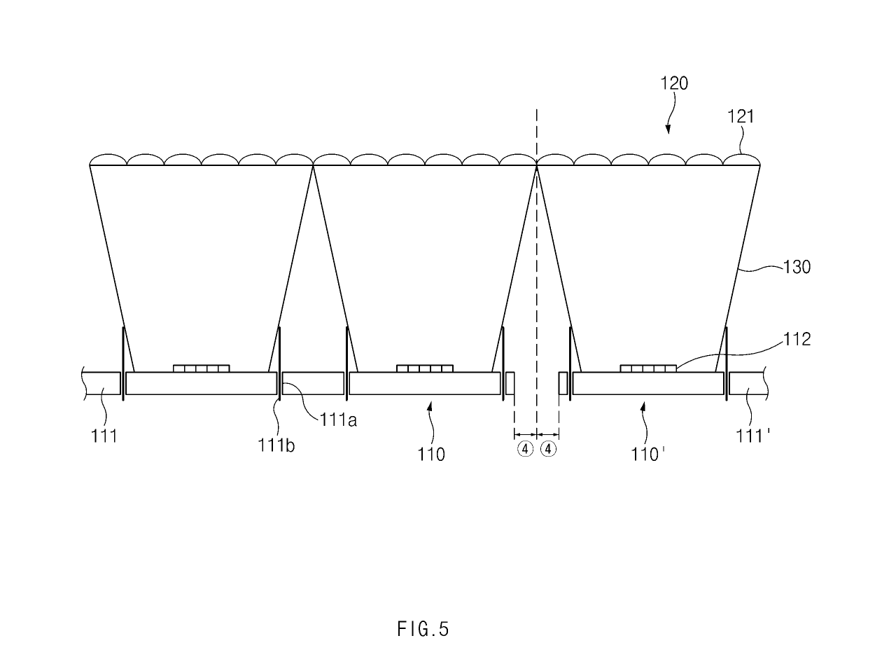

FIG. 5 is a view illustrating the panel apparatus including a plurality of display panels, according to an embodiment of the disclosure.

According to an embodiment, the panel apparatus 100 may include a plurality of display panels 110 and 110′. The plurality of display panels 110 and 110′ may constitute a module display modularized to serve as a display displaying one image. The module display may be used, for example, when constructing a display of a large-sized display apparatus such as an electric signboard installed in an arena or a screen installed in a movie theater. The plurality of display panels 110 and 110′ may include a plurality of PCBs 111 and 111′ in which at least one cluster 112 is disposed. A lenticular lens 120 and a spacer 130 may be disposed with respect to each of clusters on the PCBs 111 and 111′.

According to an embodiment, the plurality of display panels 110 and 110′ may be disposed adjacent to each other. Lenticular lenses 120 may cover external areas \textcircled{4} of the plurality of display panels 110 and 110′. Accordingly, even if the plurality of display panels 110 and 110′ are disposed adjacent to each other, any gap may not be present between the lenticular lenses 120 of the plurality of display panels 110 and 110′. Accordingly, a black zone (e.g., a zone in which an image is not displayed) may not be formed between the plurality of viewing zones formed at specified positions.

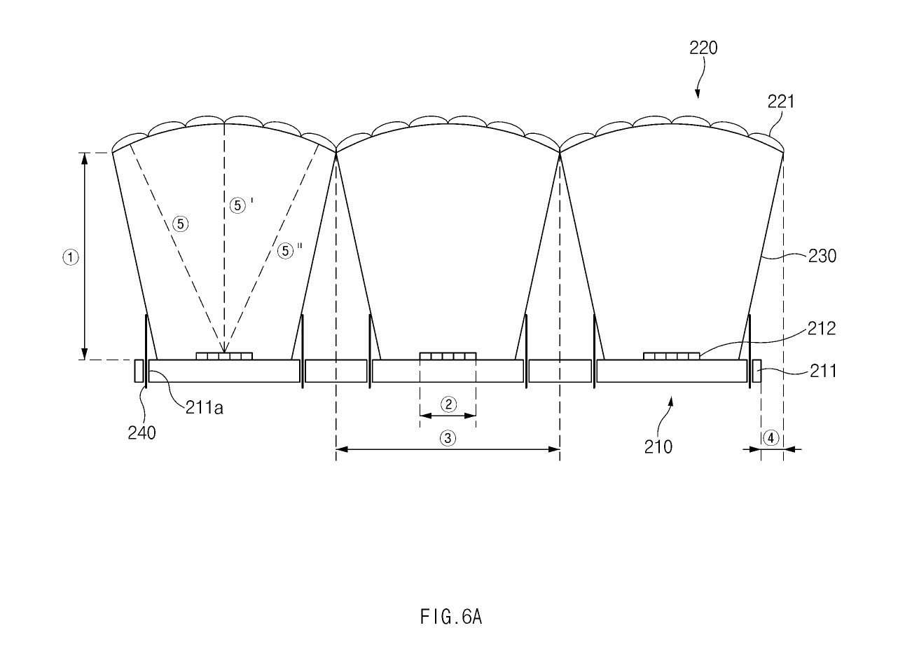

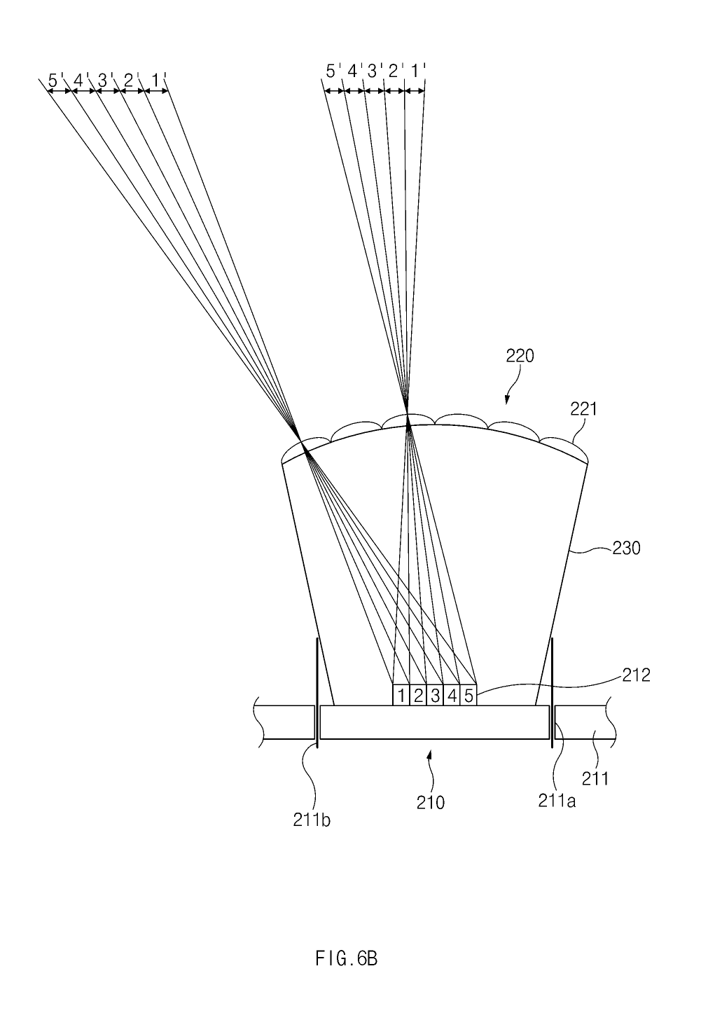

FIGS. 6A and 6B are views illustrating a display panel having a curved lenticular lens disposed therein, according to an embodiment of the disclosure.

Referring to FIG. 6A, a display panel 210 and a spacer 230 of a panel apparatus 200 according to an embodiment of the disclosure may be similar to the display panel 110 and the spacer 130 of the panel apparatus 100 according to another embodiment of the disclosure.

According to an embodiment, a distance \textcircled{1} in which a lenticular lens 220 of the panel apparatus 200 is spaced and disposed according to an embodiment of the disclosure and areas \textcircled{2}, \textcircled{3}, \textcircled{4} covered by the lenticular lens 220 may be similar to those of the lenticular lens 120 of the panel apparatus 100 according to another embodiment of the disclosure.

According to one embodiment, the lenticular lens 220 may include a plurality of lenslets 221. For example, the plurality of lenslets 221 may be convex forward of the display panel 210 and may be disposed on a curved surface having equal distances \textcircled{5}, \textcircled{5}′, \textcircled{5}″ from a straight line passing through the center of a cluster 212 while being parallel to a plurality of vertical lines V₁ to V₅. The plurality of lenslets 221 may be parallel to the vertical lines for a plurality of pixels arranged in the display panel 110. Accordingly, the lights emitted from the pixels arranged in the plurality of vertical lines V₁ to V₅ may form a plurality of viewing zones at specified positions by passing through the plurality of lenslets 221 positioned at equal distances from the straight line of the cluster 212.

Referring to FIG. 6B, the plurality of pixels, which are arranged in the plurality of vertical lines V₁ to V₅, in the cluster 212 may display images 1 to 5 taken at multiple points of view, and the lights emitted from the plurality of pixels may form a plurality of viewing zones 1′ to 5′ at specified positions by passing through the lenticular lens 220. The lenslets 221 of the lenticular lens 220 are positioned at equal distances from the straight line of the cluster 212, so the plurality of viewing zones 1′ to 5′ formed at specified positions do not overlap with each other.

Accordingly, when the plurality of lenslets 221 are disposed on the curved surface, the probability that the viewing zones 1′ to 5′ formed at specified positions overlap with each other is more reduced than lenslets disposed on a flat surface, so the probability that crosstalk is caused may be more reduced.

According to various embodiments of the disclosure described with reference to FIGS. 1 to 6B, the panel apparatuses 100 and 200 include the display panels 110 and 210 in which a plurality of clusters 112 and 212 having a plurality of pixels arranged in a zigzag pattern are spaced apart from each other by specified distances, and the optical devices (e.g., the lenticular lenses 120 and 220 and the parallax barrier) are disposed with respect to the plurality of clusters 112 and 212 to cover the entire portions of the clusters 112 and 212, thereby reducing the crosstalk, in which the plurality of viewing zones formed at specified positions overlap with each other, and Moire caused as the zone, in which the image is not formed, is formed between the plurality of viewing zones.

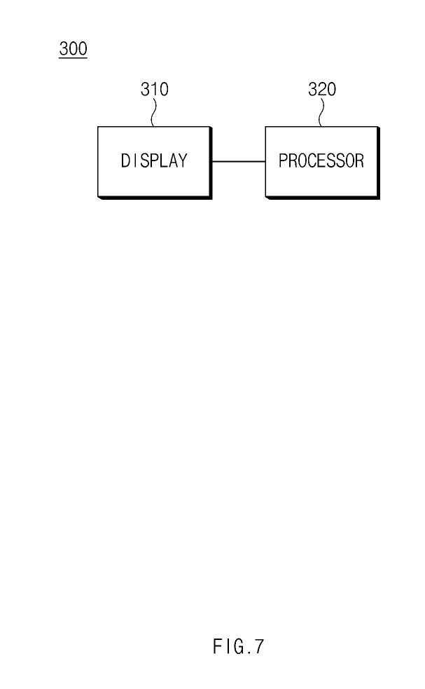

FIG. 7 is a block diagram illustrating components of the display apparatus, according to an embodiment of the disclosure.

Referring to FIG. 7, a display apparatus 300 may include a display 310 and a processor 320. For example, the display apparatus 300 may include a large-sized display device, such as an electric signboard installed in an arena or a screen installed in a movie theater, as well as a home appliance display device such as a television (TV), a monitor, a mobile phone, a laptop computer, a tablet PC.

According to one embodiment, the display 310 may include the panel apparatuses 100 and 200 illustrated in FIGS. 1 to 6B. For example, the display 310 may display a 3D image.

According to one embodiment, the processor 320 may control the display 310 to display the image on the display 310. For example, the processor 320 may alternately display images taken at multiple points of view on a plurality of pixels.

Accordingly, the display apparatus 300 may form a plurality of viewing zones at specified positions. The adjacent viewing zones of the plurality of viewing zones may be a left-eye viewing zone and a right-eye viewing zone, and the display apparatus 300 may display the 3D image on the display 310.

At least a part of a device (e.g., modules or functions thereof) or a method (e.g., operations) according to various embodiments may be, for example, implemented by instructions stored in a computer-readable storage media in the form of a program module. The instruction, when executed by a processor, may cause the processor to perform a function corresponding to the instruction. A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and an embedded memory. The instructions may include codes formed by a compiler or codes executable by an interpreter.

According to various embodiments, operations performed by modules, program modules, or other components may be executed by a successive method, a parallel method, a repeated method, or a heuristic method, at least some operations may be executed in a difference sequence or omitted, or another operation may be added. Embodiments disclosed in the disclosure are provided for the illustrative purpose and the technical scope described in the disclosure is not limited thereto. Accordingly, the technical scope of the disclosure should be interpreted as including all modifications or various changes based on the technical spirit of the disclosure.

1. A panel apparatus comprising:
a display panel including a cluster in which a plurality of pixels are arranged in a first vertical line and a second vertical line adjacent to the first vertical line in a zigzag pattern; and
an optical device disposed on a front surface of the display panel to cover an entire portion of the cluster,
wherein the pixels arranged in the first vertical line display an image taken at a first point of view and the pixels arranged in the second vertical line display an image taken at a second point of view.

2. The panel apparatus of claim 1, wherein the pixels include a light emitting diode (LED).

3. The panel apparatus of claim 1, wherein the first vertical line and the second vertical line are arranged without overlapping with each other and without being spaced apart from each other, and
wherein a horizontal line of each pixel arranged in the first vertical line and a horizontal line of each pixel arranged in the second vertical line are arranged without overlapping with each other.

4. The panel apparatus of claim 1, wherein the plurality of pixels include a plurality of R pixels, G pixels, and B pixels, and
wherein a first R pixel, a first G pixel, and a first B pixel are arranged in the first vertical line, and a second R pixel, a second G pixel, and a second B pixel are arranged in the second vertical line.

5. The panel apparatus of claim 1, wherein the optical device is disposed to be spaced forward from the display panel by a specified distance, and
wherein the optical device covers an area wider than the cluster.

6. The panel apparatus of claim 1, wherein the optical device includes a lenticular lens including a plurality of lenslets parallel to the first vertical line.

7. The panel apparatus of claim 6, wherein the plurality of lenslets are disposed on a flat surface parallel to the display panel.

8. The panel apparatus of claim 6, wherein the plurality of lenslets are convex forward of the display panel and are disposed on a curved surface having equal distances from a straight line passing through a center of the cluster while being parallel to the first vertical line.

9. The panel apparatus of claim 1, wherein the optical device includes a parallax barrier having a plurality of slits parallel to the first vertical line.

10. The panel apparatus of claim 1, further comprising:
a spacer interposed between the display panel and the optical device to maintain a specified distance between the optical device and the display panel.

11. The panel apparatus of claim 10, wherein the spacer is formed around the cluster and formed to be inclined outward of the cluster.

12. The panel apparatus of claim 10, wherein a surface of the spacer includes a material to absorb a light.

13. The panel apparatus of claim 1, wherein the display panel includes:
a plurality of clusters disposed to be spaced apart from each other by a specified distance; and
a plurality of optical devices to cover the plurality of clusters, respectively, and
wherein the plurality of optical devices cover an entire portion of the display panel.

14. The panel apparatus of claim 13, wherein the display panel includes a plurality of printed circuit board (PCB) on which at least one of the clusters is disposed.

15. A display apparatus comprising:
a display; and
a processor to display an image on the display,
wherein the display includes:
a display panel including a cluster in which a plurality of pixels are arranged in a first vertical line and a second vertical line adjacent to the first vertical line in a zigzag pattern; and
an optical device disposed on a front surface of the display panel to cover an entire portion of the cluster, and
wherein the pixels arranged in the first vertical line display an image taken at a first point of view and the pixels arranged in the second vertical line display an image taken at a second point of view.
